(19) United States
(12) Patent Application Publication
(10) Pub. No.: US 2026/0288354 A1
(43) Pub. Date: Sep. 24, 2026

(54) CONTROL DEVICE, DISK DEVICE, CONTROL METHOD, AND STORAGE MEDIUM

(71) Applicants: KABUSHIKI KAISHA TOSHIBA, Kawasaki-shi (JP); TOSHIBA ELECTRONIC DEVICES & STORAGE CORPORATION, Kawasaki-shi (JP)

(72) Inventors: Naoto NOMIYA, Yokohama Kanagawa (JP); Tetsuo KURIBAYASHI, Yokohama Kanagawa (JP)

(73) Assignees: KABUSHIKI KAISHA TOSHIBA, Kawasaki-shi (JP); TOSHIBA ELECTRONIC DEVICES & STORAGE CORPORATION, Kawasaki-shi (JP)

(21) Appl. No.: 19/370,897

(22) Filed: Oct. 28, 2025

(30) Foreign Application Priority Data
Mar. 18, 2025 (JP) 2025-043127

(51) Int. Cl. G06F 3/06

(52) U.S. Cl. CPC G06F 3/064; G06F 3/0604; G06F 3/0676

(57) ABSTRACT

According to an embodiment, a control device includes a controller. A recording area of the control device includes a first recording area including a plurality of disk sectors. The controller is configured to be able to execute a formatting process for allocating a plurality of logical block addresses to the plurality of disk sectors included in the first recording area in sequential order. The formatting process includes dividing the first recording area into a plurality of small segments, each including two or more of the disk sectors. The formatting process includes performing a segment formatting process for each of the small segments in sequential order, the segment formatting process including a write process for writing the logical block addresses to the disk sectors within each of the small segments in sequential order and a read process for reading the logical block addresses written to the disk sectors in the write process in sequential order.

### CROSS-REFERENCE TO RELATED APPLICATION

This application is based upon and claims the benefit of priority from Japanese Patent Application No. 2025-043127, filed on Mar. 18, 2025; the entire contents of which are incorporated herein by reference.

### FIELD

Embodiments described herein relate generally to a control device, a disk device, a control method, and a storage medium.

### BACKGROUND

A control device for a disk device capable of executing a formatting process is known. The formatting process executed by such a control device includes performing a write process for writing logical block addresses to a plurality of disk sectors in a recording area of a disk device in sequential order and performing a read process for reading the written logical block addresses in sequential order. For example, when an uncorrectable error occurs in the read process, the control device rewrites logical block addresses to disk sectors other than the disk sector where the error has occurred. Thus, the time required for the formatting process may be lengthened.

### BRIEF DESCRIPTION OF THE DRAWINGS

FIG. 1 is a block diagram showing a configuration of a disk device according to an embodiment.

FIG. 2 is a cross-sectional view showing a disk according to the embodiment.

FIG. 3 is a diagram showing an example of a recording surface of the disk according to the embodiment.

FIG. 4 is a diagram schematically showing a recording area of the disk device according to the embodiment.

FIG. 5 is a diagram showing an example of a method for allocating LBAs in the formatting process of the embodiment.

FIG. 6 is a flowchart showing a part of a procedure of an example of the formatting process according to the embodiment.

FIG. 7 is a flowchart showing another part of the procedure of the example of the formatting process of the embodiment.

FIG. 8 is a diagram showing an example of a segment formatting process according to the embodiment.

FIG. 9 is a diagram showing another example of the segment formatting process according to the embodiment.

FIG. 10 is a diagram showing an example of a segment formatting process for a final small segment of the embodiment.

### DETAILED DESCRIPTION

According to an embodiment, a control device for use in a disk device having a recording area is provided. According to the embodiment, the control device includes a controller. The recording area includes a first recording area including a plurality of disk sectors. The controller is configured to be able to execute a formatting process for allocating a plurality of logical block addresses to the plurality of disk sectors included in the first recording area in sequential order. The formatting process includes dividing the first recording area into a plurality of small segments, each including two or more of the disk sectors. The formatting process includes performing a segment formatting process for each of the small segments in sequential order, the segment formatting process including a write process for writing the logical block addresses to the disk sectors within each of the small segments in sequential order and a read process for reading the logical block addresses written to the disk sectors in the write process in sequential order.

Hereinafter, a control device, a disk device, a control method, and a storage medium according to embodiments will be described with reference to the drawings.

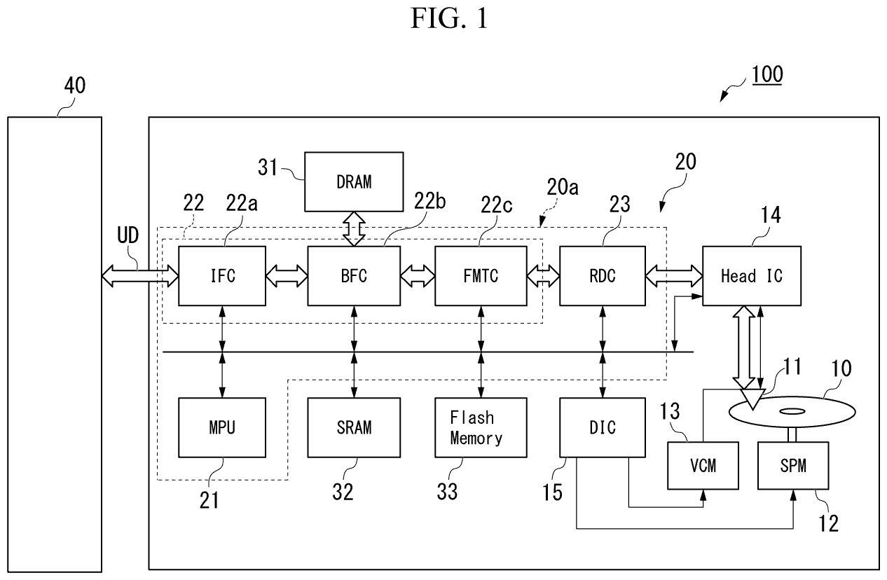

FIG. 1 is a block diagram showing a configuration of a disk device 100 according to the present embodiment. The disk device 100 according to the present embodiment shown in FIG. 1 is a magnetic disk device into which a hard disk drive is built. The disk device 100 can store information as digital data. The disk device 100 is driven on the basis of a command from a higher-level device 40. The higher-level device 40 is, for example, a server, a personal computer, or the like. The higher-level device 40 is not particularly limited as long as it is a device that issues commands to the disk device 100. The higher-level device 40 can cause the disk device 100 to record information and can read data recorded in the disk device 100.

As shown in FIG. 1, the disk device 100 includes a disk 10, a head 11, a spindle motor 12, a voice coil motor 13, a head amplifier IC 14, and a control device 20.

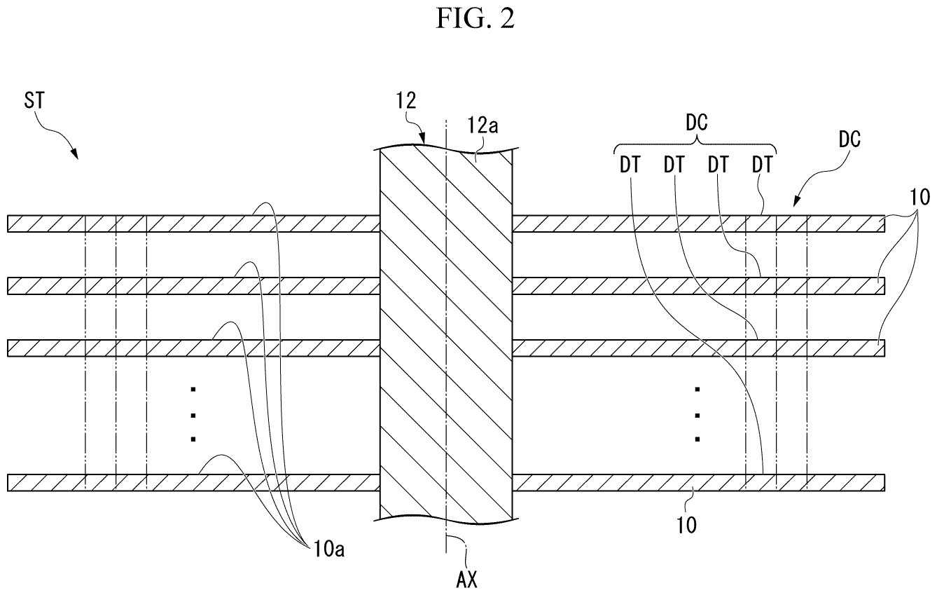

In the present embodiment, the disk 10 is a magnetic disk. The disk 10 is disk-shaped. FIG. 2 is a cross-sectional view showing the disk 10. As shown in FIG. 2, in the present embodiment, a plurality of disks 10 are provided at intervals in an axial direction of a shaft 12a. The number of disks 10 is not particularly limited as long as it is one or more. The plurality of disks 10 are connected to the shaft 12a of the spindle motor 12. Each disk 10 is rotated around a central axis AX of the shaft 12a by the spindle motor 12. In the following description, a direction in which the central axis AX of the shaft 12a extends may be simply referred to as an “axial direction.” A radial direction centered on the central axis AX may be simply referred to as a “radial direction.” A circumferential direction around the central axis AX may be simply referred to as a “circumferential direction.”

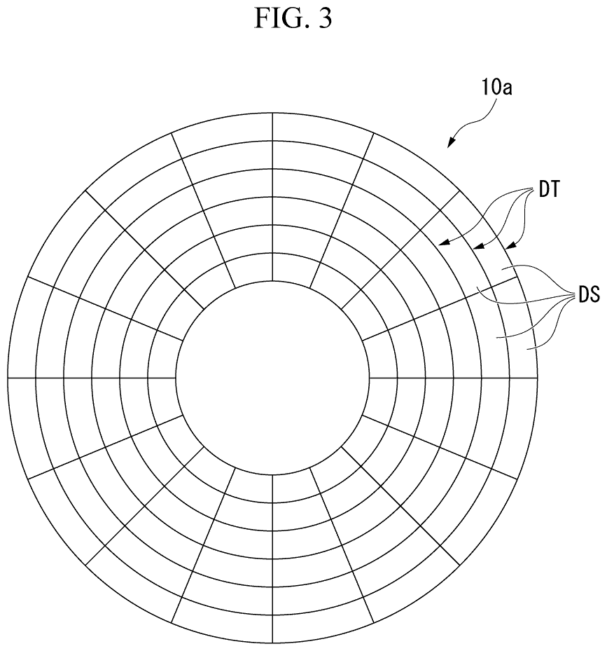

Each disk 10 has a recording surface 10a. In addition, each disk 10 may have both the front and back sides as recording surfaces 10a. That is, each disk 10 may have two recording surfaces 10a. FIG. 3 is a diagram showing an example of the recording surface 10a of the disk 10. As shown in FIG. 3, a plurality of annular disk tracks DT are formed on the recording surface 10a. The plurality of disk tracks DT are arranged in a radial direction and concentrically. Each disk track DT has a plurality of disk sectors DS arranged in the circumferential direction. A certain amount of digital data can be recorded in each of the disk sectors DS. A recording capacity of each disk sector DS is, for example, 512 bytes. The recording capacity of each disk sector DS is not particularly limited. The number of disk sectors DS provided in the recording surface 10a is not particularly limited.

In the present embodiment, the disk device 100 has a recording area ST including a plurality of recording surfaces 10a. The recording area ST includes a plurality of disk sectors DS on the plurality of recording surfaces 10a. As shown in FIG. 2, the recording area ST has a plurality of disk cylinders DC. Each of the plurality of disk cylinders DC includes a plurality of disk tracks DT. The plurality of disk cylinders DC are arranged side by side in the radial direction. The plurality of disk tracks DT included in each disk cylinder DC are arranged at the same position in the radial direction. The plurality of disk tracks DT included in each disk cylinder DC are disk tracks DT formed on different recording surfaces 10a. In FIG. 2, some of the plurality of disk cylinders DC are virtually indicated by two-dot chain lines.

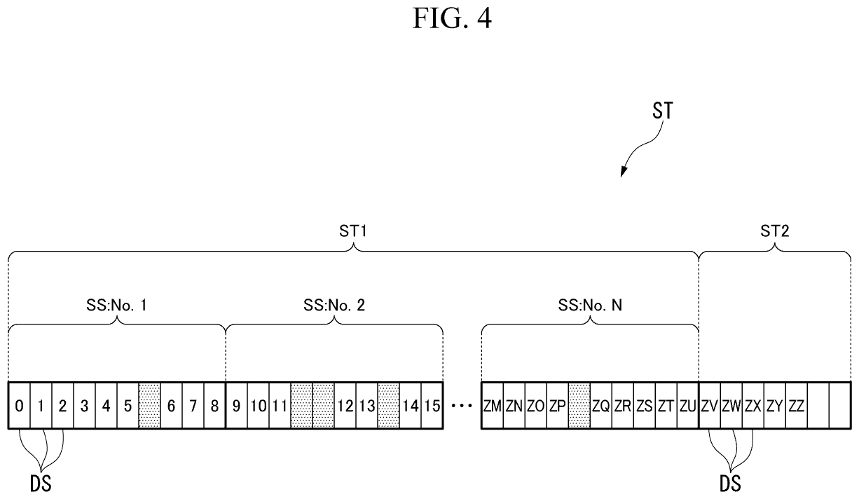

FIG. 4 is a diagram schematically showing the recording area ST of the disk device 100. As shown in FIG. 4, the recording area ST has a first recording area ST1 and a second recording area ST2. Each of the first recording area ST1 and the second recording area ST2 includes a plurality of disk sectors DS. The first recording area ST1 is a user data recording area where user data UD transmitted from the higher-level device 40 is recorded. The second recording area ST2 is a replacement area including a plurality of disk sectors DS used in place of the disk sectors DS of the first recording area ST1. When the disk sectors DS included in the first recording area ST1 include a disk sector DS determined to be unusable, the second recording area ST2 is used as an area where user data UD is recorded in place of the disk sectors DS determined to be unusable. The cases where a disk sector DS is determined to be unusable include, for example, a case where an unrecovered write error in which data cannot be written to the disk sector DS occurs, a case where an unrecovered read error in which data in the disk sector DS cannot be read occurs, and the like.

In the example of FIG. 4, shaded disk sectors DS among the plurality of disk sectors DS in the first recording area ST1 are disk sectors DS determined to be unusable. In FIG. 4, an example in which five disk sectors DS are determined to be unusable is shown. In the example of FIG. 4, five disk sectors DS in the second recording area ST2 are used as disk sectors DS for recording user data UD instead of the five disk sectors DS determined to be unusable. A logical block address (LBA) is allocated to each disk sector DS for recording user data UD. The logical block address is a number allocated to identify the disk sector DS. A number indicating the logical block address is recorded in each disk sector DS for recording user data UD in a formatting process to be described below. In the example of FIG. 4, a plurality of logical block addresses from 0 to ZZ are recorded in the plurality of disk sectors DS for recording user data UD. In the following description, the logical block address may be referred to as an “LBA.”

The head 11 shown in FIG. 1 is a magnetic head capable of reading data recorded on the disk 10 and writing data to the disk 10. Although not shown, the head 11 has a read head for reading data recorded on the disk 10 and a write head for writing data to the disk 10. The head 11 is moved to a position facing the recording surface 10a and a position not facing the recording surface 10a by the voice coil motor 13. At the position facing the recording surface 10a, the head 11 is capable of reading data from the recording surface 10a and writing data to the recording surface 10a. The head 11 is provided for each recording surface 10a. The plurality of heads 11 are moved together in the radial direction by the voice coil motor 13.

Although not shown, the head amplifier IC 14 has a read amplifier and a write driver. The read amplifier amplifies a signal of data read from the disk 10 by the head 11 and outputs the amplified signal to a read/write channel 23 to be described below in the control device 20. The write driver outputs a write current to the head 11 according to the data output from the read/write channel 23. The head 11 writes data to the disk 10 on the basis of the write current output from the write driver. The head amplifier IC 14 is mounted on, for example, a flexible board (not shown) that is attached to a head assembly (not shown) that includes the head 11. The flexible board electrically connects the head 11 and the control device 20.

The control device 20 includes a controller 20a, a driver IC 15, a first volatile memory 31, a second volatile memory 32, and a non-volatile memory 33. The controller 20a, the driver IC 15, the first volatile memory 31, the second volatile memory 32, and the non-volatile memory 33 are mounted on, for example, a circuit board (not shown).

The driver IC 15 controls the driving of the spindle motor 12 and the voice coil motor 13 on the basis of a command from the controller 20a.

The controller 20a is a system controller that controls the disk device 100. The controller 20a is, for example, a large-scale integrated circuit (LSI) referred to as a system-on-a-chip (SoC) in which a plurality of elements are integrated on a single chip. The controller 20a is electrically connected to a head amplifier IC 14, a driver IC 15, a first volatile memory 31, a second volatile memory 32, and a non-volatile memory 33. The controller 20a has a microprocessor 21, a hard disk controller 22, and a read/write channel 23.

The hard disk controller 22 controls a data transfer between the higher-level device 40 and the read/write channel 23 on the basis of a command from the microprocessor 21. The hard disk controller 22 is electrically connected to the microprocessor 21, the read/write channel 23, the head amplifier IC 14, the driver IC 15, the first volatile memory 31, the second volatile memory 32, and the non-volatile memory 33. The hard disk controller 22 has an interface control unit 22a, a buffer control unit 22b, and a format control unit 22c. The interface control unit 22a controls an interface with the higher-level device 40. The interface control unit 22a reads a command input from the higher-level device 40 and performs data reception and transfer processes and the like. The buffer control unit 22b temporarily records data input from the higher-level device 40 via the interface control unit 22a and data read from the disk 10 in the first volatile memory 31. The format control unit 22c converts the format of the data input from the buffer control unit 22b and the data input from the read/write channel 23.

The read/write channel 23 executes signal processing of data transmitted from the disk 10 to the higher-level device 40 and data transmitted from the higher-level device 40 to the disk 10 on the basis of a command from the microprocessor 21. The read/write channel 23 has, for example, a function of measuring the signal quality of the data.

The first volatile memory 31 and the second volatile memory 32 are semiconductor memories in which stored data is lost when the supply of electric power stops. In the present embodiment, data is temporarily recorded in the first volatile memory 31 by the buffer control unit 22b. In the present embodiment, the first volatile memory 31 is a dynamic random-access memory (DRAM). In the second volatile memory 32, data necessary for processing in each part of the disk device 100 is recorded. In the present embodiment, the second volatile memory 32 is a static random-access memory (SRAM). The first volatile memory 31 and the second volatile memory 32 may be integrated into one volatile memory. The first volatile memory 31 may be an SRAM, a synchronous dynamic random-access memory (SDRAM), a ferroelectric random-access memory (FeRAM), a magnetoresistive random-access memory (MRAM), or the like. The second volatile memory 32 may be a DRAM, an SDRAM, a FeRAM, an MRAM, or the like.

The non-volatile memory 33 is a semiconductor memory that continues to hold recorded data even if the supply of electric power stops. In the present embodiment, the non-volatile memory 33 is a flash memory. The non-volatile memory 33 is, for example, a NOR or NAND type flash memory. At least a part of the program for driving the disk device 100, system data required before data is read and written from and to the disk 10, and the like are recorded in the non-volatile memory 33.

In FIG. 1, a white arrow indicates a flow of the user data UD. The user data UD input from the higher-level device 40 to the disk device 100 is input to the buffer control unit 22b via the interface control unit 22a and is temporarily recorded in the first volatile memory 31 by the buffer control unit 22b. The user data UD recorded in the first volatile memory 31 is read by the buffer control unit 22b, and is converted into a format recordable on the disk 10 in the format control unit 22c. The converted user data UD is transmitted to the head amplifier IC 14 via the read/write channel 23 and is written from the head 11 to the disk 10. When the user data UD recorded on the disk 10 is read by the higher-level device 40, for example, the user data UD is read in a procedure that is the reverse of a procedure in which the above-described user data UD is written to the disk 10.

The microprocessor 21 is a main controller that controls each part of the disk device 100. The microprocessor 21 controls the voice coil motor 13 via the driver IC 15 and executes servo control for positioning the head 11. The microprocessor 21 controls the spindle motor 12 via the driver IC 15 and rotates the disk 10. The microprocessor 21 controls an operation for writing data to the disk 10 (a write operation). The microprocessor 21 selects a destination for storing data to be written to the disk 10. The microprocessor 21 controls an operation for reading data recorded on the disk 10 (a read operation). The microprocessor 21 controls the processing of data to be read from the disk 10. The microprocessor 21 is electrically connected to each part of the disk device 100.

The controller 20a is configured to be able to execute a formatting process. The formatting process is a process for allocating a plurality of LBAs to a plurality of disk sectors DS included in the first recording area ST1 in sequential order. The formatting process is executed before the disk device 100 is used for recording user data UD. The formatting process, for example, may be executed before the disk device 100 is shipped or may be executed by the user after the shipment. In addition, a command support program may be installed in the disk device 100 for the user to cause the control device 20 to execute the formatting process. In the present embodiment, the formatting process is executed by the microprocessor 21.

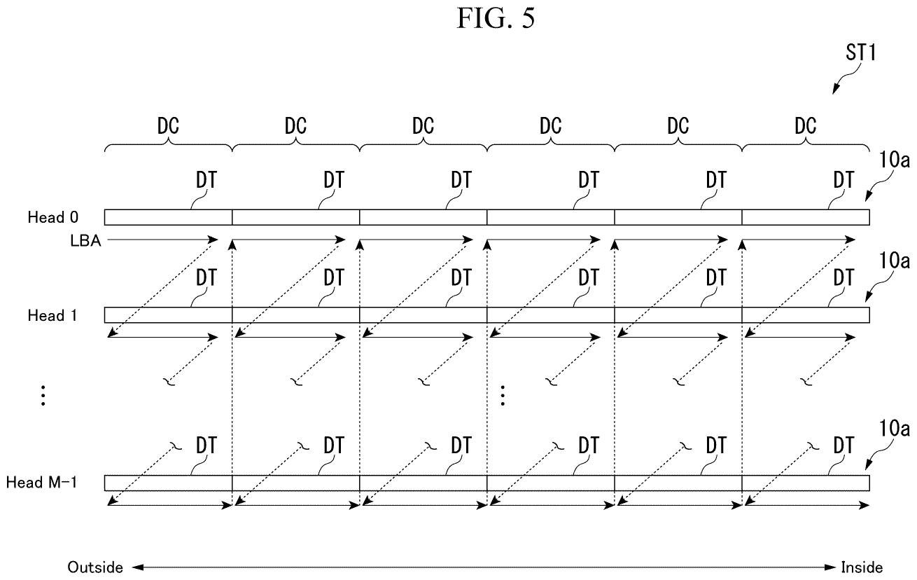

FIG. 5 is a diagram showing an example of a method for allocating LBAs in the formatting process. The left-right direction in FIG. 5 indicates the radial direction centered on the central axis AX. The right side of the left-right direction in FIG. 5 is an inward side in the radial direction. The left side of the left-right direction in FIG. 5 is an outward side in the radial direction. As shown in FIG. 5, the allocation of LBAs, for example, starts from the disk track DT of the recording surface 10a corresponding to the head 11 with the smallest logical number among the disk tracks DT of the disk cylinder DC located on the outermost side in the radial direction. The logical number of the head 11 is a number allocated to each of the plurality of heads 11. The logical number of the head 11 is a number that is appropriately determined in accordance with the performance of the head 11 or the like regardless of the physical position of the head 11. In the example of FIG. 5, logical numbers from 0 to M-1 are allocated to M heads 11. The allocation of LBAs to a plurality of disk sectors DS in one disk track DT is performed in the order in which the plurality of disk sectors DS are arranged in the circumferential direction.

After an LBA is allocated to a disk track DT corresponding to the head 11 of No. 0 in the disk cylinder DC located on the outermost side in the radial direction, an LBA is allocated to a disk track DT corresponding to the head 11 of No. 1 having the next smallest logical number within the same disk cylinder DC. Hereinafter, likewise, LBAs are sequentially allocated to disk tracks DT within the disk cylinder DC. When the allocation of an LBA to the disk cylinder DC located on the outermost side in the radial direction is completed, an LBA is allocated to a disk cylinder DC located adjacent to the disk cylinder DC located on the inward side in the radial direction. The method for allocating LBAs to the disk cylinder DC is similar to the method for allocating LBAs to the disk cylinder DC located on the outermost side in the radial direction. Hereinafter, likewise, LBAs are sequentially allocated to a plurality of disk cylinders DC.

In the present embodiment, when the disk sectors DS included in the recording area ST are arranged in the order in which the above-described LBAs are allocated, the second recording area ST2 is arranged consecutively after the first recording area ST1. In the present embodiment, the second recording area ST2 is included in the same disk cylinder DC as a final small segment FSS to be described below. When the disk sectors DS included in the recording area ST are arranged in the order in which the LBAs are allocated, the second recording area ST2 is arranged consecutively after the final small segment FSS.

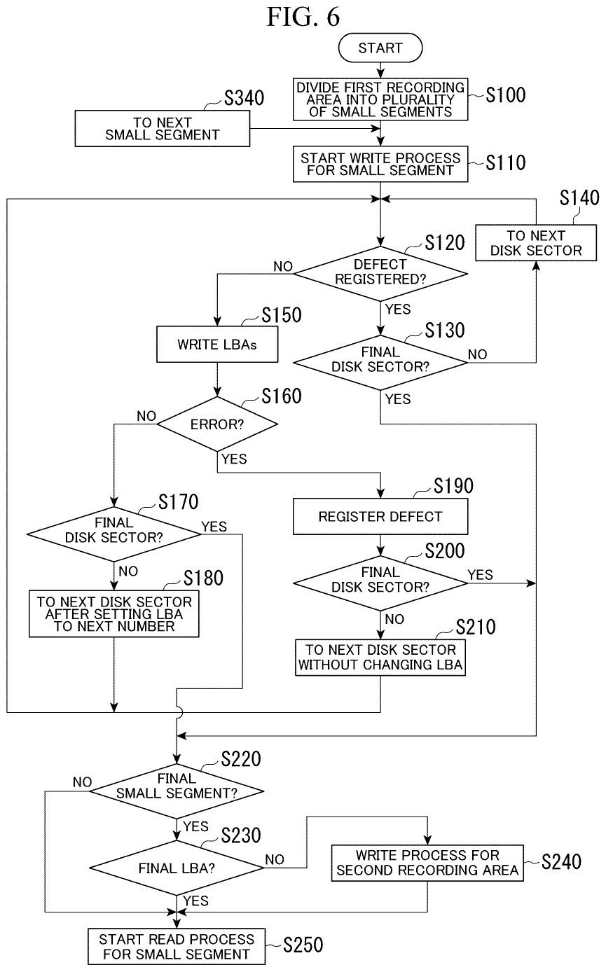

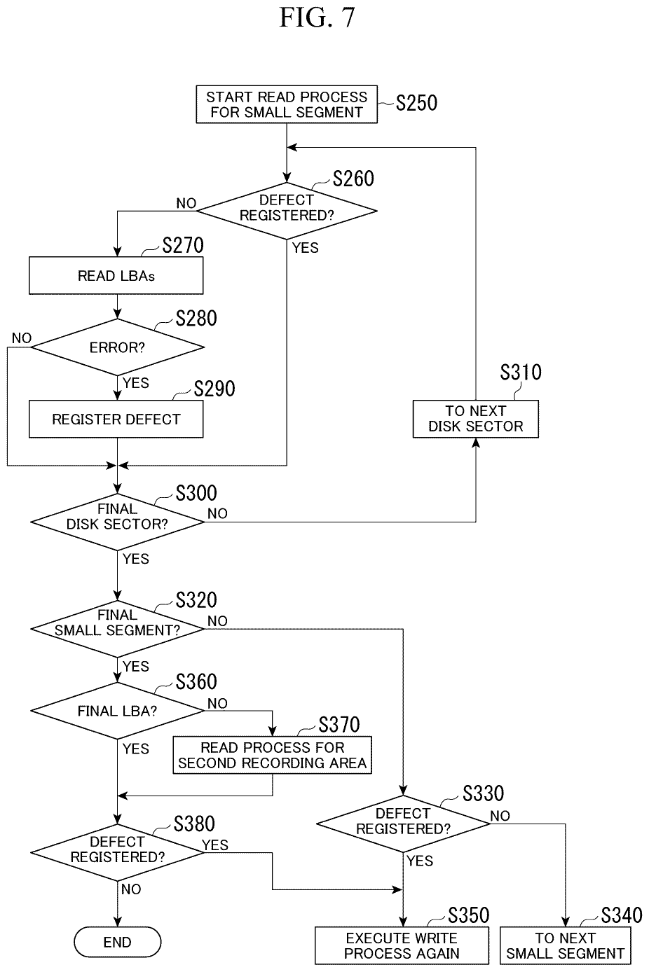

FIG. 6 is a flowchart showing a part of a procedure of an example of the formatting process. FIG. 7 is a flowchart showing another part of the procedure of the example of the formatting process. In the present embodiment, the procedure of the formatting process shown in FIG. 6 and FIG. 7 is executed by the microprocessor 21 of the controller 20a. As shown in FIG. 6, when the formatting process is started, the controller 20a divides the first recording area ST1 into a plurality of small segments SS (step S100). As shown in FIG. 4, each of the plurality of small segments SS includes two or more disk sectors DS. In other words, the formatting process includes dividing the first recording area ST1 into the plurality of small segments SS, each including two or more disk sectors DS. In step S100, the controller 20a divides the first recording area ST1 into the plurality of small segments SS on the basis of information previously stored in the non-volatile memory 33 or the like.

In the example of FIG. 4, each small segment SS includes 10 disk sectors DS. The number of disk sectors DS included in each small segment SS is not particularly limited as long as it is two or more. In the present embodiment, the number of disk sectors DS included in the small segments SS is the same. A plurality of small segments SS may include two or more small segments SS including different numbers of disk sectors DS. In the example of FIG. 4, the first recording area ST1 is divided into N small segments SS from a small segment SS of No. 1 to a small segment SS of No. N.

When all the disk sectors DS included in the first recording area ST1 are arranged in the order in which the above-described LBAs are allocated, the small segments SS of Nos. 1 to N are arranged side by side in numerical order. In the present embodiment, in each small segment SS, the plurality of disk sectors DS included in the small segment SS are included in the same disk cylinder DC. Each small segment SS is, for example, a segment in which the first recording area ST1 is divided in units of disk tracks DT. A method by which the small segments SS are divided is not particularly limited. Each small segment SS may be a segment in which the first recording area ST1 is divided in units of disk cylinders DC. Each small segment SS may be a segment provided across a plurality of disk tracks DT. A separator by which each small segment SS is separated may be provided between disk sectors DS within one disk track DT. A plurality of small segments SS may be provided within one disk track DT.

As shown in FIG. 6, in the formatting process, the controller 20a starts a write process for the small segment SS (step S110). The controller 20a first starts the write process for the small segment SS with the smallest number. The write process is a process for writing LBAs to a plurality of disk sectors DS in each small segment SS in sequential order. In the write process, the controller 20a uses the head 11 to write LBAs to a plurality of disk sectors DS included in the small segment SS according to the above-described sequential order in sequential order. In the write process, the controller 20a determines whether or not the disk sector DS to which the LBA is to be written has been registered as defective (step S120). The disk device 100 stores a first defect list and a second defect list for registering address information of a disk sector DS that has been determined to be unusable due to a defect. The first defect list and the second defect list, for example, are stored in the non-volatile memory 33. The first defect list is a list in which address information of disk sectors DS determined to be unusable in tests and the like during the manufacturing stage of the disk device 100 is registered. The first defect list has address information of disk sectors DS determined to be unusable registered therein before the first formatting process is performed. The second defect list is a list in which address information of disk sectors DS determined to be unusable is registered during and after the formatting process is performed. In step S120, the controller determines whether or not a disk sector DS to which an LBA is to be written has been registered as defective on the basis of the first defect list and the second defect list. The address information of the disk sectors DS registered in the first defect list and the second defect list is address information indicating an absolute position of the disk sector DS represented by a cylinder head sector (CHS). The address information of the disk sector DS represented by the cylinder head sector is also used to specify the disk sector DS to which the LBA is to be written in the formatting process.

When it is determined that the disk sector DS has been registered as defective in step S120 (step S120: YES), the controller 20a determines whether or not the disk sector DS is the final disk sector DS of the small segment SS without writing the LBA to the disk sector DS (step S130). When it is determined that the disk sector DS is not the final disk sector DS of the small segment SS in step S130 (step S130: NO), the controller 20a sets the disk sector DS to which the LBA is to be written to the next disk sector DS (step S140). After step S140, the controller 20a performs step S120 again. When it is determined that the disk sector DS is the final disk sector DS of the small segment SS in step S130 (step S130: YES), the controller 20a performs step S220 to be described below.

When it is determined that the disk sector DS has not been registered as defective in step S120 (step S120: NO), the controller 20a writes an LBA to the disk sector DS (step S150). The controller 20a determines whether or not an error has occurred in writing the LBA to the disk sector DS (step S160). In step S160 of the present embodiment, the controller 20a determines whether or not an unrecoverable error has occurred in writing the LBA. When it is determined that no error has occurred in step S160 (step S160: NO), the controller 20a determines whether or not the disk sector DS to which the LBA has been written is the final disk sector DS in the small segment SS (step S170). When it is determined that the disk sector DS is not the final disk sector DS of the small segment SS in step S170 (step S170: NO), the controller 20a sets the LBA number to the next number and sets the disk sector DS to which the LBA is to be written to the next disk sector DS (step S180). After step S180, the controller 20a performs step S120 again. When it is determined that the disk sector DS is the final disk sector DS of the small segment SS in step S170 (step S170: YES), the controller 20a performs step S220 to be described below.

When it is determined that an error has occurred in writing the LBA in step S160 (step S160: YES), the controller 20a determines that the disk sector DS in which the error has occurred is defective and registers the address information of the disk sector DS in the above-described second defect list (step S190). In addition, when it is not possible to write the LBA normally, the controller 20a may attempt to write the LBA again one or more times. In this case, the controller 20a may determine that an error has occurred in writing the LBA in step S160 if the LBA is not written normally even after attempting to write the LBA a predetermined number of times.

After the address information of the disk sector DS where the error has occurred is registered in the second defect list, the controller 20a determines whether or not the disk sector DS is the final disk sector DS in the small segment SS (step S200). When it is determined that the disk sector DS is not the final disk sector DS in the small segment SS in step S200 (step S200: NO), the controller 20a sets the disk sector DS to which the LBA is to be written to the next disk sector DS without changing the LBA number (step S210). After step S210, the controller 20a performs step S120 again. When it is determined that the disk sector DS is the final disk sector DS in the small segment SS in step S200 (step S200: YES), the controller 20a performs step S220 to be described below.

When it is determined that the disk sector DS is the final disk sector DS of the small segment SS in which the write process is currently being performed in steps S130, S180, and S200, the controller 20a determines whether or not the small segment SS is the final small segment SS (step S220). When it is determined that the small segment SS is not the final small segment SS in step S220 (step S220: NO), the controller 20a starts a read process for the small segment SS (step S250).

When it is determined that the small segment SS is the final small segment SS in step S220 (step S220: YES), the controller 20a determines whether or not the finally written LBA number in the small segment SS is the final LBA number (step S230). When it is determined that the LBA number is the final LBA number in step S230 (step S230: YES), the controller 20a starts a read process for the small segment SS (step S250). When it is determined that the LBA number is not the final LBA number in step S230 (step S230: NO), the controller 20a executes a write process for the second recording area ST2 (step S240). In step S240, the controller 20a writes the remaining LBAs to the disk sectors DS of the second recording area ST2 in sequential order. In step S240, the controller 20a writes the LBA while making the determination as in steps S120 and S160. After step S240 ends, the controller 20a starts a read process for the final small segment SS (step S250).

The read process in the formatting process is a process for reading the LBAs written to the disk sectors DS in the write process in sequential order. In the read process, the controller 20a performs a read process on the plurality of disk sectors DS in the small segment SS in sequential order identical to the sequential order in which the LBAs were written. As shown in FIG. 7, if the read process for the small segment SS starts, the controller 20a determines whether or not the disk sector DS from which the LBA is to be read has been registered as defective (step S260). In step S260, the controller 20a determines whether or not the disk sector DS has been registered as defective on the basis of the first defect list and the second defect list. When it is determined that the disk sector DS has been registered as defective (step S260: YES), the controller 20a determines whether or not the disk sector DS is the final disk sector DS in the small segment SS for which the read process is being performed (step S300). When it is determined that the disk sector DS is not the final disk sector DS in step S300 (step S300: NO), the controller 20a sets the disk sector DS from which the LBA is to be read to the next disk sector DS (step S310). After step S310, the controller 20a performs step S260 again. When it is determined that the disk sector DS is the final disk sector DS in step S300 (step S300: YES), the controller 20a performs step S320 to be described below.

When it is determined that the disk sector DS from which the LBA is to be read has not been registered as defective in step S260 (step S260: NO), the controller 20a reads the LBA from the disk sector DS (step S270). The controller 20a determines whether or not an error has occurred in reading the LBA from the disk sector DS (step S280). In step S280 of the present embodiment, the controller 20a determines whether or not an unrecoverable error has occurred in reading the LBA. When it is determined that no error has occurred in step S280 (step S280: NO), the controller 20a determines whether or not the disk sector DS from which the LBA has been read is the final disk sector DS in the small segment SS (step S300).

When it is determined that an error has occurred in reading the LBA in step S280 (step S280: YES), the controller 20a determines that the disk sector DS in which the error has occurred is defective and registers the address information of the disk sector DS in the second defect list (step S290). In addition, when it is not possible to read the LBA normally, the controller 20a may attempt to read the LBA once or more again. In this case, the controller 20a may determine that an error has occurred in reading the LBA in step S280 when the LBA has not been normally read even after a predetermined number of attempts to read the LBA. After registering the address information of the disk sector DS in the second defect list, the controller 20a determines whether or not the disk sector DS is the final disk sector DS in the small segment SS (step S300).

When it is determined that the disk sector DS is the final disk sector DS of the small segment SS in step S300 (step S300: YES), the controller 20a determines whether or not the small segment SS for which the read process is being performed is the final small segment SS (step S320). When it is determined that the small segment SS is not the final small segment SS in step S320 (step S320: NO), the controller 20a determines whether or not there is a disk sector DS registered as defective in the second defect list during the read process for the small segment SS (step S330). When it is determined that there is no disk sector DS registered as defective in step S330 (step S330: NO), the controller 20a sets the target small segment SS to the next small segment SS (step S340). As shown in FIG. 6, after the target small segment SS is set to the next small segment SS, the controller 20a starts the write process for the next small segment SS again from step S110.

As shown in FIG. 7, when it is determined that there are one or more disk sectors DS registered as defective in the read process in step S330 (step S330: YES), the controller 20a executes the write process again for the small segment SS corresponding thereto (step S350). The write process to be executed again is executed as in the process from step S110 described above. In the write process to be executed again, it is determined that the disk sector DS registered as defective in the read process has also been registered as defective in step S120. Therefore, in the write process to be executed again, no LBA is written to the disk sector DS registered as defective in the read process. After the write process executed again ends, the controller 20a executes the read process again for the small segment SS as in the process from step S250.

When it is determined that the small segment SS is the final small segment SS in step S320 (step S320: YES), the controller 20a determines whether or not the finally read LBA number is the final LBA number (step S360). When it is determined that the LBA number is not the final LBA number in step S360 (step S360: NO), the controller 20a executes a read process for the second recording area ST2 (step S370). In step S370, the controller 20a reads the LBAs written to the disk sectors DS within the second recording area ST2 in sequential order until the final LBA number is read. In step S370, the controller 20a reads the LBAs while making the determination as in steps S260 and S280. If the final LBA number is read in step S370, the controller 20a executes step S380 to be described below.

When it determined that the LBA number is the final LBA number in step S360 (step S360: YES), the controller 20a determines whether or not there is a disk sector DS registered as defective in the second defect list in the read process for the small segment SS (step S380). When the process for reading the LBA in the second recording area ST2 has been executed in step S370, the controller 20a determines whether or not there is a disk sector DS registered as defective in the read process for the small segment SS and the read process for the second recording area ST2 in step S380. When it is determined that there is no disk sector DS registered as defective in step S380 (step S380: NO), the controller 20a ends the read process and ends the formatting process. When it is determined that there are one or more disk sectors DS registered as defective in step S380 (step S380: YES), the controller 20a executes the write process for the small segment SS again (step S350).

In addition, when the write process is performed for the final small segment SS again, at least one of the disk sectors DS included in the final small segment SS is registered in the first defect list or the second defect list. Therefore, the controller 20a cannot write the LBA to the end using only the disk sectors DS within the final small segment SS. Therefore, the controller 20a also performs the write process for the second recording area ST2 in step S240.

As described above, the controller 20a executes the formatting process. As described above, in the formatting process, the controller 20a executes a write process for writing an LBA to one small segment SS and a read process for reading the LBA therefrom, and then executes a write process and a read process for the next small segment SS. That is, in the formatting process, the controller 20a executes a segment formatting process SFP including the write process and the read process for the respective small segments SS in sequential order. In other words, the formatting process includes executing the segment formatting process for the respective small segments SS in sequential order. The segment formatting process SFP for the small segments SS other than the final small segment SS is a first segment formatting process SFP1. The first segment formatting process SFP1 is a process before step S340 in which movement to the next small segment SS is performed from the above-described step S110. The segment formatting process SFP for the final small segment SS is a second segment formatting process SFP2. The second segment formatting process SFP2 is a process until the formatting process ends from step S110.

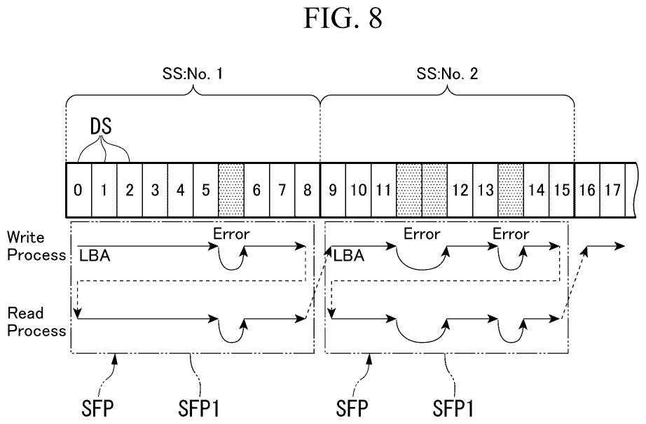

FIG. 8 is a diagram showing an example of the segment formatting process SFP. In FIG. 8, an example of the procedure of the first segment formatting process SFP1 for the small segments SS other than the final small segment SS is shown. In the example of FIG. 8, the first segment formatting process SFP1 for the first small segment SS and the second small segment SS is shown. In FIG. 8, the shaded disk sectors DS are disk sectors DS registered in the first defect list or disk sectors DS registered in the second defect list due to an error occurring in the write process.

As shown in FIG. 8, if the first segment formatting process SFP1 starts for the first small segment SS, a write process starts to write LBAs to a plurality of disk sectors DS included in the first small segment SS in sequential order. In FIG. 8, an example in which an error occurs in writing an LBA in the seventh disk sector DS among the plurality of disk sectors DS included in the first small segment SS is shown. The controller 20a determines that an error has occurred in writing an LBA to the seventh disk sector DS in the above-described step S160. Thereby, the LBA is not written to the seventh disk sector DS and the LBA is written to the next eighth disk sector DS. In FIG. 8, an example in which the sixth LBA, which would normally be written to the seventh disk sector DS in the first small segment SS, is written to the next eighth disk sector DS is shown. Thus, if an error occurs in writing an LBA during the write process, the segment formatting process SFP includes skipping the disk sector DS in which the error has occurred and writing the LBA scheduled to be written to the disk sector DS in which the error has occurred to the next disk sector DS within the small segment SS.

If the write process for the first small segment SS is completed, the read process for the first small segment SS starts. The controller 20a reads the LBAs in sequential order from the first disk sector DS of the first small segment SS. Because the seventh disk sector DS is registered as defective in step S190, the controller 20a determines that the disk sector DS is registered as defective in the determination of the above-described step S260 for the disk sector DS, and does not read the LBA for the disk sector DS. In the example of FIG. 8, a case where no error occurs in the read process for the first small segment SS is shown. If the read process for the first small segment SS is completed, the controller 20a starts the first segment formatting process SFP1 for the next second small segment SS.

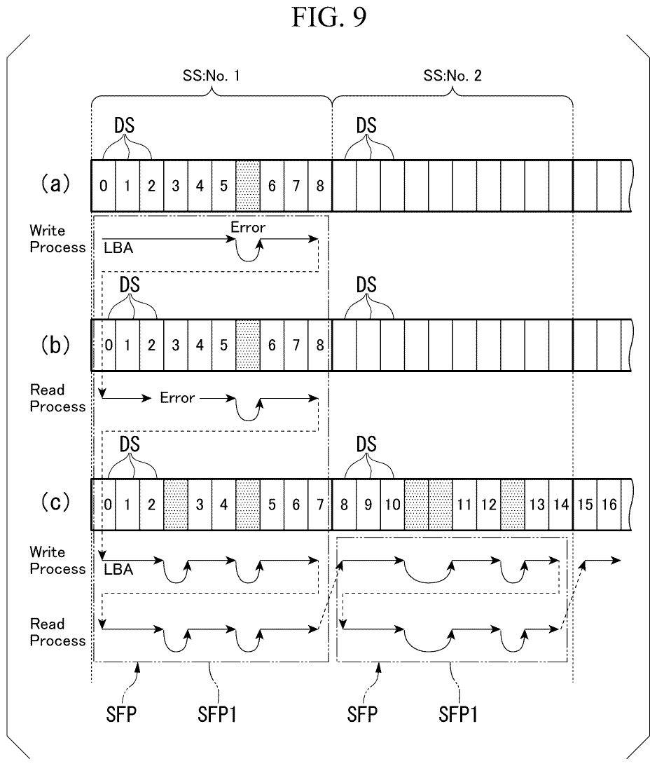

FIG. 9 is a diagram showing another example of the segment formatting process SFP. In FIG. 9, an example of the procedure of the first segment formatting process SFP1 for the small segments SS other than the final small segment SS is shown. In the example of FIG. 9, the first segment formatting process SFP1 for the first small segment SS and the second small segment SS is shown. In (a) of FIG. 9, the write process for the first small segment SS is shown. In (b) of FIG. 9, the read process for the first small segment SS is shown. In (c) of FIG. 9, the rewrite process and the reread process for the first small segment SS and the first segment formatting process SFP1 for the second small segment SS are shown. In FIG. 9, the shaded disk sectors DS are disk sectors DS registered in the first defect list or the second defect list.

In FIG. 9, an example of a case where an error has occurred in the read process for the first small segment SS is shown. After the write process is performed for the first small segment SS as shown in (a) of FIG. 9, the read process starts for the first small segment SS as shown in (b) of FIG. 9. In addition, in (a) of FIG. 9, as in FIG. 8, an example of a case where a write error occurs in the seventh disk sector DS is shown. In (b) of FIG. 9, an example of a case where an error in which the LBA cannot be read occurs in the fourth disk sector DS of the first small segment SS is shown. The controller 20a determines that an error has occurred in the fourth disk sector DS of the first small segment SS in the above-described step S280 and registers the address information of the disk sector DS in the second defect list. Thus, the segment formatting process SFP includes storing the address information of the disk sector DS in which the error has occurred when the error has occurred in reading the LBA in the read process.

In the example of FIG. 9, the controller 20a determines that an error has occurred in the read process and that there is a disk sector DS registered as defective in step S330 and executes a rewrite process as shown in (c) of FIG. 9. That is, the segment formatting process SFP includes executing a write process again after the read process ends if there is a disk sector DS in which an error has occurred in the read process. In the rewrite process, no LBA is written not only to the seventh disk sector DS in which a write error has occurred, but also to the fourth disk sector DS registered as defective in the read process. That is, the segment formatting process SFP includes rewriting an LBA to a disk sector DS within the small segment SS while skipping the disk sector DS in which an error has occurred in the read process in the write process executed again. Therefore, some of the numbers of the LBAs written in the rewrite process will be shifted from the numbers of the LBAs written in the write process initially performed for the small segment SS. In addition, at the start of the rewrite process, the fourth and seventh disk sectors DS are already registered in the second defect list. Thus, LBAs are not written to these disk sectors DS on the basis of the determination in step S120.

In the example of FIG. 9, a case where LBAs 0 to 8 are allocated to the first small segment SS in the initial write process and LBAs 0 to 7 are allocated to the small segment SS in the rewrite process is shown. After the rewrite process for the first small segment SS is completed, the controller 20a executes a reread process for the first small segment SS. When the reread process is completed without any errors, the controller 20a ends the first segment formatting process SFP1 for the first small segment SS and starts the first segment formatting process SFP1 for the second small segment SS.

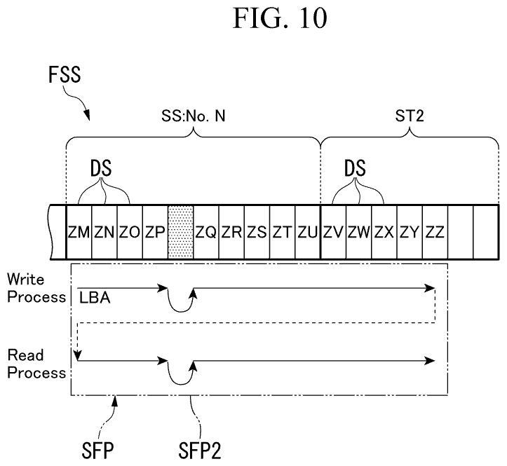

FIG. 10 is a diagram showing an example of the second segment formatting process SFP2 for the final small segment SS. In FIG. 10, an example of the procedure of the second segment formatting process SFP2 for the final small segment SS is shown. In FIG. 10, an example of the case where LBAs are also written to the second recording area ST2 is shown. The final small segment SS is an N^{th} small segment SS and is the final small segment FSS. In the example of FIG. 10, the number of the LBA written to the final disk sector DS of the final small segment FSS is No. ZU and is a number before No. ZZ which is the final LBA number. Therefore, the LBAs from No. ZV are written to the disk sector DS of the second recording area ST2 according to the above-described step S240. Thus, the formatting process includes writing the remaining LBAs to the disk sectors DS within the second recording area ST2 when writing of all LBAs is not completed after the write process executed for the final small segment FSS for which the segment formatting process SFP is finally performed among the plurality of small segments SS is completed. In the present embodiment, the formatting process includes writing the remaining LBAs to the disk sectors DS within the second recording area ST2 in sequential order before the read process is executed for the final small segment FSS.

In the example of FIG. 10, the write process of the second segment formatting process SFP2 is completed by writing a ZZ^{th} LBA to the disk sector DS of the second recording area ST2. If the write process of the second segment formatting process SFP2 is completed, the read process for the final small segment FSS starts. That is, the formatting process includes executing the read process for the final small segment FSS after the writing of the remaining LBAs to the second recording area ST2 is completed. In the example of FIG. 10, the LBA is written to the second recording area ST2. Therefore, after the reading of the LBA written to the final small segment FSS is completed, the LBA written to the second recording area ST2 is read according to the above-described step S370. That is, when the LBA is written to the second recording area ST2, the formatting process includes reading the LBAs of the second recording area ST2 in sequential order after the read process for the final small segment FSS is completed.

In the example of FIG. 10, the read process of the second segment formatting process SFP2 is completed by reading the final number of the LBA written to the second recording area ST2, i.e., No. ZZ. In the example of FIG. 10, a case where no error has occurred in the read process is shown. When an error has occurred in the read process of the second segment formatting process SFP2, a rewrite process and a reread process are executed as in the above-described first segment formatting process SFP1.

The control method in the present embodiment is a control method performed by the control device 20 described above. At least some of the functions of the control device 20 described above are implemented, for example, by the controller 20a executing a program, i.e., software, stored in the disk 10 or the non-volatile memory 33. The program is a program that causes the control device 20, which is a computer, to execute the control method of the present embodiment. At least some of the functions of the control device 20 may be implemented by hardware including circuit units such as, for example, a large-scale integration (LSI) circuit, an application-specific integrated circuit (ASIC), a field-programmable gate array (FPGA), and a graphics processing unit (GPU), or may be implemented by software and hardware in cooperation. The control device 20 may include a plurality of devices.

A medium storing the program for causing the control device 20, which is a computer, to execute the control method of the present embodiment is not particularly limited, and may be a storage medium other than the disk 10 or the non-volatile memory 33. A storage medium in which the program is stored may be the same as a storage medium in which the above-described first and second defect lists are stored or may be a different storage medium. The storage medium in which the program is stored may be another storage medium provided in the disk device 100 or may be a storage medium provided separately from the disk device 100. The above-described storage medium may be, for example, a flexible disk, a magneto-optical disk, a random-access memory (RAM), a read only memory (ROM), a CD-ROM, a hard disk drive (HDD), a solid-state drive (SSD), a flash memory, or the like. The program for causing the control device 20, which is the computer, to execute the control method of the present embodiment may be transmitted to the control device 20 via a telecommunication line. The storage medium in which the above-described first and second defect lists are stored may be a storage medium other than the disk 10 and the non-volatile memory 33. The storage medium may be a storage medium arranged outside the disk device 100. In this case, the disk device 100 may communicate with the storage medium via a telecommunication line and acquire various types of information from the storage medium.

According to the present embodiment, the control device 20 is a control device of the disk device 100 having the recording area ST. The control device 20 includes a controller 20a. The recording area ST includes a first recording area ST1 including a plurality of disk sectors DS. The controller 20a is configured to be able to execute a formatting process for allocating a plurality of logical block addresses, i.e., LBAs, to the plurality of disk sectors DS included in the first recording area ST1 in sequential order. The formatting process includes dividing the first recording area ST1 into a plurality of small segments SS, each including two or more disk sectors DS. The formatting process includes performing a segment formatting process SFP for each small segment SS in sequential order, the segment formatting process including a write process for writing LBAs to the disk sectors DS in each small segment SS in sequential order and a read process for reading the LBAs written to the disk sectors DS in the write process in sequential order. Therefore, for example, even if an error occurs in the read process and it becomes necessary to execute the write process again, it is not necessary to execute the write process for the entire first recording area ST1 again and it is only necessary to execute the write process for the small segment SS where the segment formatting process SFP is being performed again. Thereby, it is possible to suppress an increase in the time required for the formatting process compared to when it is necessary to execute the write process for the entire first recording area ST1 again. Therefore, for example, even if the user causes the control device 20 of the disk device 100 to execute the formatting process after the disk device 100 is shipped, it is possible to suppress an increase in the time required for the user to use the disk device 100. Therefore, it is possible to execute the formatting process on the user's side. Thereby, it is unnecessary for a manufacturer that manufactures and sells the disk device 100 to execute the formatting process before shipping the disk device 100, and it is possible to shorten the time required for the disk device 100 to be shipped. Moreover, even if the formatting process is executed before the disk device 100 is shipped, it is possible to suppress an increase in the time required for the formatting process and it is possible to suppress an increase in the time required for the disk device 100 to be shipped.

According to the present embodiment, the segment formatting process SFP includes storing address information of the disk sector DS where an error has occurred when the error has occurred in reading the LBA in the read process. The segment formatting process SFP includes executing the write process again after the read process is completed when there is a disk sector DS where the error has occurred in the read process. The segment formatting process SFP includes rewriting the LBA to the disk sector DS within the small segment SS while skipping the disk sector DS where the error has occurred in the read process in the write process that is executed again. Therefore, when the error has occurred in the read process for the small segment SS, the LBA can be reallocated to the disk sector DS within the small segment SS other than the disk sector DS where the error has occurred within the small segment SS. Moreover, because the write process that is executed again is performed for the small segment SS, an increase in the time required for the write process that is executed again can be suppressed compared to when the write process that is executed again is performed for the entire first recording area ST1.

According to the present embodiment, the segment formatting process SFP includes skipping the disk sector DS where the error has occurred when the error has occurred in writing of the LBA in the write process and writing the LBA scheduled to be written to the disk sector DS where the error has occurred to the next disk sector DS within the small segment SS. Therefore, for example, compared to when the LBA scheduled to be written to the disk sector DS where the error has occurred in the write process is instead written to a disk sector DS provided outside the small segment SS, the disk sector DS having the LBA with the consecutive number can be arranged at a physically closer position. Thereby, when the LBA scheduled to be written to the disk sector DS where the error has occurred in the write process is accessed after the formatting process is completed, there is no need to move the head 11 greatly. Therefore, the time required for the access process for each disk sector DS can be shortened and the deterioration in the sequential performance of the disk device 100 can be suppressed. Therefore, the deterioration in the responsiveness of the disk device 100 can be suppressed.

Moreover, in the present embodiment, after the disk device 100 is shipped to a user, defects in disk sectors DS detected at times other than the time when the formatting process is executed are also registered in the second defect list as subsequent defects. Disk sectors DS registered in the second defect list at times other than the time when the formatting process is executed are replaced by vacant disk sectors DS in the second recording area ST2, regardless of the positions of the disk sectors DS. Therefore, as the number of subsequent defects detected at times other than the time when the formatting process is executed increases, the number of LBAs physically located apart even though they are consecutive numbers may increase and the sequential performance of the disk device 100 may be reduced. However, it is possible to reallocate LBAs so that the physical positions of consecutive LBAs are close to each other by executing the above-described formatting process on the basis of the second defect list. Therefore, even if the number of subsequent defects in disk sectors DS increases, the deterioration in the sequential performance of the disk device 100 can be improved by performing the formatting process.

According to the present embodiment, the recording area ST has a second recording area ST2 including a plurality of disk sectors DS. The formatting process includes writing the remaining LBAs to the disk sectors DS within the second recording area ST2 when writing of all LBAs is not completed after the write process executed for the final small segment FSS where the segment formatting process SFP is finally performed among the plurality of small segments SS is completed. Therefore, even if there is a disk sector DS registered as defective in the first recording area ST1, all LBAs can be allocated to the disk sectors DS within the recording area ST.

According to the present embodiment, the formatting process includes writing the remaining LBAs to the disk sectors DS within the second recording area ST2 in sequential order before the read process is executed for the final small segment FSS when writing of all LBAs is not completed after the write process executed for the final small segment FSS is completed. The formatting process includes executing the read process for the final small segment FSS after writing of the remaining LBAs in the second recording area ST2 is completed. The formatting process includes reading the LBAs in the second recording area ST2 in sequential order after the read process for the final small segment FSS is completed when the LBAs are written to the second recording area ST2. Therefore, it is possible to write and read the LBAs for the second recording area ST2 in the second segment formatting process SFP2 executed for the final small segment FSS. Thereby, it is possible to easily shorten the time required for the formatting process compared to when writing and reading of the LBAs for the second recording area ST2 are executed separately from writing and reading of the LBAs for the final small segment FSS. Therefore, it is possible to further suppress an increase in the time required for the formatting process.

According to the present embodiment, when the disk sectors DS to which the LBAs are allocated are arranged in sequential order, the second recording area ST2 is arranged consecutively after the final small segment FSS. Therefore, it is easy to shorten a physical distance between the final small segment FSS and the second recording area ST2. Thereby, it is possible to shorten the time required until the writing of the LBAs to the second recording area ST2 is performed after the writing of the LBAs to the final small segment FSS ends. Moreover, it is possible to shorten the time required until the LBAs written to the second recording area ST2 are read after the reading of the LBAs written to the final small segment FSS ends. Thereby, it is possible to further suppress an increase in the time required for the formatting process.

According to the present embodiment, the recording area ST includes a plurality of disk cylinders DC, each including a plurality of disk tracks DT. The final small segment FSS and the second recording area ST2 are included in the same disk cylinder DC. Radial positions of the disk sectors DS included in the same disk cylinder DC are the same. Therefore, in the formatting process, when writing or reading of LBAs is switched between the final small segment FSS and the second recording area ST2, it is not necessary to move the head 11 in the radial direction with the voice coil motor 13. Thereby, it is possible to further suppress an increase in the time required for the formatting process.

According to the present embodiment, in each small segment SS, the plurality of disk sectors DS included in the small segment SS are included in the same disk cylinder DC. Therefore, while the segment formatting process SFP is being executed for each small segment SS, it is not necessary to move the head 11 in the radial direction with the voice coil motor 13. Thereby, it is possible to further shorten the time required for the segment formatting process SFP. Therefore, it is possible to further suppress an increase in the time required for the formatting process.

According to at least one embodiment described above, a control device for use in a disk device having a recording area is provided. The control device includes a controller. The recording area includes a first recording area including a plurality of disk sectors. The controller is configured to be able to execute a formatting process for allocating a plurality of logical block addresses to the plurality of disk sectors included in the first recording area in sequential order. The formatting process includes dividing the first recording area into a plurality of small segments, each including two or more of the disk sectors. The formatting process includes performing a segment formatting process for each of the small segments in sequential order, the segment formatting process including a write process for writing the logical block addresses to the disk sectors within each of the small segments in sequential order and a read process for reading the logical block addresses written to the disk sectors in the write process in sequential order. Therefore, for example, even if an error occurs in the read process and it becomes necessary to execute the write process again, it is not necessary to execute the write process for the entire first recording area again and it is only necessary to execute the write process for the small segment where the segment formatting process is being performed again. Thereby, it is possible to suppress an increase in the time required for the formatting process.

Sequential order in which LBAs are allocated is not particularly limited. When the LBAs are allocated to the second recording area, the LBAs may be written to and read from the second recording area after the write process and the read process for the final small segment are completed. The recording area of the disk device may have a third recording area other than the first recording area and the second recording area. System data used for controlling the disk device may be recorded in the third recording area.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control device for use in a disk device having a recording area, the control device comprising:
a controller,
wherein the recording area includes a first recording area including a plurality of disk sectors,
wherein the controller is configured to be able to execute a formatting process for allocating a plurality of logical block addresses to the plurality of disk sectors included in the first recording area in sequential order, and
wherein the formatting process includes
dividing the first recording area into a plurality of small segments, each including two or more of the disk sectors; and
performing a segment formatting process for each of the small segments in sequential order, the segment formatting process including a write process for writing the logical block addresses to the disk sectors within each of the small segments in sequential order and a read process for reading the logical block addresses written to the disk sectors in the write process in sequential order.

2. The control device according to claim 1, wherein the segment formatting process includes
storing address information of the disk sector where an error has occurred when the error has occurred in reading of the logical block address in the read process;
executing the write process again after the read process is completed when there is a disk sector where the error has occurred in the read process; and
rewriting the logical block address to the disk sector within the small segment while skipping the disk sector where the error has occurred in the read process in the write process that is executed again.

3. The control device according to claim 1, wherein the segment formatting process includes skipping the disk sector where an error has occurred when the error has occurred in writing of the logical block address in the write process and writing the logical block address scheduled to be written to the disk sector where the error has occurred to the next disk sector within the small segment.

4. The control device according to claim 3,
wherein the recording area has a second recording area including a plurality of disk sectors, and
wherein the formatting process includes writing the remaining logical block addresses to the disk sectors within the second recording area when writing of all the logical block addresses has not been completed after completion of the write process that is executed for a final small segment where the segment formatting process is finally performed among the plurality of small segments.

5. The control device according to claim 4, wherein the formatting process includes
writing the remaining logical block addresses to the disk sectors within the second recording area in sequential order before the read process is executed for the final small segment when the writing of all the logical block addresses has not been completed after the completion of the write process executed for the final small segment;
executing the read process for the final small segment after the writing of the remaining logical block addresses to the second recording area is completed; and
reading the logical block addresses of the second recording area in sequential order after the completion of the read process for the final small segment when the logical block addresses have been written to the second recording area.

6. The control device according to claim 4, wherein the second recording area is arranged consecutively after the final small segment when the disk sectors included in the recording area are arranged in the order in which the logical block addresses are allocated.

7. The control device according to claim 6,
wherein the recording area includes a plurality of disk cylinders, each including a plurality of disk tracks, and
wherein the final small segment and the second recording area are included in the same disk cylinder.

8. The control device according to claim 1,
wherein the recording area includes a plurality of disk cylinders, each including a plurality of disk tracks, and
wherein the plurality of disk sectors included in the small segment are included in the same disk cylinder in each of the small segments.

9. A disk device having a recording area, the disk device comprising:
a disk;
a head capable of reading data recorded on the disk and writing data to the disk; and
a control device,
wherein the control device includes a controller,
wherein the recording area has a first recording area including a plurality of disk sectors,
wherein the controller is configured to be able to execute a formatting process for allocating a plurality of logical block addresses to the plurality of disk sectors included in the first recording area in sequential order, and
wherein the formatting process includes dividing the first recording area into a plurality of small segments, each including two or more of the disk sectors; and
performing a segment formatting process for each of the small segments in sequential order, the segment formatting process including a write process for writing the logical block addresses to the disk sectors within each of the small segments in sequential order and a read process for reading the logical block addresses written to the disk sectors in the write process in sequential order.

10. A control method for use in a disk device having a recording area, the control method comprising:
a formatting process for allocating a plurality of logical block addresses to a plurality of disk sectors included in a first recording area within the recording area in sequential order,
wherein the formatting process includes
dividing the first recording area into a plurality of small segments, each including two or more of the disk sectors; and
performing a segment formatting process for each of the small segments in sequential order, the segment formatting process including a write process for writing the logical block addresses to the disk sectors within each of the small segments in sequential order and a read process for reading the logical block addresses written to the disk sectors in the write process in sequential order.

11. The control method according to claim 10, wherein the segment formatting process includes
storing address information of the disk sector where an error has occurred when the error has occurred in reading of the logical block address in the read process;
executing the write process again after the read process is completed when there is a disk sector where the error has occurred in the read process; and
rewriting the logical block address to the disk sector within the small segment while skipping the disk sector where the error has occurred in the read process in the write process that is executed again.

12. The control method according to claim 10, wherein the segment formatting process includes skipping the disk sector where an error has occurred when the error has occurred in writing of the logical block address in the write process and writing the logical block address scheduled to be written to the disk sector where the error has occurred to the next disk sector within the small segment.

13. The control method according to claim 12,
wherein the recording area has a second recording area including a plurality of disk sectors, and
wherein the formatting process includes writing the remaining logical block addresses to the disk sectors within the second recording area when writing of all the logical block addresses has not been completed after completion of the write process that is executed for a final small segment where the segment formatting process is finally performed among the plurality of small segments.

14. The control method according to claim 13, wherein the formatting process includes
writing the remaining logical block addresses to the disk sectors within the second recording area in sequential order before the read process is executed for the final small segment when the writing of all the logical block addresses has not been completed after the completion of the write process executed for the final small segment;
executing the read process for the final small segment after the writing of the remaining logical block addresses to the second recording area is completed; and
reading the logical block addresses of the second recording area in sequential order after the completion of the read process for the final small segment when the logical block addresses have been written to the second recording area.

15. The control method according to claim 13, wherein the second recording area is arranged consecutively after the final small segment when the disk sectors to which the logical block addresses are allocated are arranged in the order.

16. The control method according to claim 15,
wherein the recording area includes a plurality of disk cylinders, each including a plurality of disk tracks, and
wherein the final small segment and the second recording area are included in the same disk cylinder.

17. The control method according to claim 10,
wherein the recording area includes a plurality of disk cylinders, each including a plurality of disk tracks, and
wherein the plurality of disk sectors included in the small segment are included in the same disk cylinder in each of the small segments.

18. A non-transitory storage medium storing a software program capable of being executed by a computer,
wherein the computer executes a control method for use in a disk device having a recording area if the software program is executed,
wherein the control method includes a formatting process for allocating a plurality of logical block addresses to a plurality of disk sectors included in a first recording area within the recording area in sequential order, and
wherein the formatting process includes
dividing the first recording area into a plurality of small segments, each including two or more of the disk sectors; and
performing a segment formatting process for each of the small segments in sequential order, the segment formatting process including a write process for writing the logical block addresses to the disk sectors within each of the small segments in sequential order and a read process for reading the logical block addresses written to the disk sectors in the write process in sequential order.
